(19) United States
(12) Patent Application Publication
(10) Pub. No.: US 2014/0268773 A1
(43) Pub. Date: Sep. 18, 2014

(54) MODULAR INTERCONNECT SYSTEM FOR LED LIGHTING

(71) Applicant: US LED, Ltd., Houston, TX (US)

(72) Inventor: Nicholas J. DeKeyser, Katy, TX (US)

(73) Assignee: US LED, Ltd., Houston, TX (US)

(21) Appl. No.: 14/209,968

(22) Filed: Mar. 13, 2014

Related U.S. Application Data
(60) Provisional application No. 61/794,500, filed on Mar. 15, 2013.

(51) Int. Cl. F21V 23/06; F21V 29/00; F21V 5/04

(52) U.S. Cl. CPC F21V 23/06; F21V 5/04; F21V 29/2293
USPC 362/249.02; 362/311.02; 362/362; 362/373; 439/527

(57) ABSTRACT

A modular system of LED lighting provides for the use of LED lighting modules that are connectable using a interconnect module that provides structural rigidity. The LED lighting modules provide a sealed connection between adjoining LED modules, allowing their use under environmental conditions that may involve transient exposure to liquids such as water. Variants of the module allow using interconnect modules that allow flexible connections where rigidity is of less concern. Mounting features integrated into the interconnect modules allow mounting the interconnected lighting units to an installation site as desired.

### TECHNICAL FIELD

The present invention relates to the field of lighting systems utilizing light emitting diodes (“LEDs”), and in particular to a modular system for connecting lighting modules.

### BACKGROUND ART

Luminescent lighting displays, such as cabinet and flat panel signs, billboards, storefront awnings, and the like, often utilize illuminated signage fixtures commonly referred to as “channel letters” to produce a variety of lighting effects. Such channel letters typically comprise one or more channels, with internal light sources, each channel being shaped as a letter, number, design, or a combination thereof, and each generally having a rigid, translucent plastic cover. The term “lighting displays” also includes architectural lighting, interior lighting for homes and businesses, and other applications where it is desirable to provide evenly bright, long-lasting lighting with low power requirements.

The common light sources, such as fluorescent lamps, halogen lamps, gaseous discharge xenon lamps, neon lights, and the like, have been used in such lighting displays and fixtures, such as channel letters, for illuminated signs. These types of light sources typically convert a significant portion of the power or energy consumed into heat that may be difficult to dissipate from a sealed display, and may damage electronic circuitry contained therein, or may be inappropriate for temperature-controlled environments. In addition, these lamps consume significant amounts of power, and typically require large power supplies or transformers. Some of these lamps and power supplies also generate substantial electromagnetic emissions, which may interfere with radio communications and thus can be problematic in certain applications and locations. Finally, these light sources may have a relatively short operational life, necessitating frequent replacement.

As a result of these known problems with traditional lighting sources, there are many potential areas of application in luminescent lighting displays for LEDs. This is because LED systems, among other advantages, enable creation of a lighting display that: (1) is far more durable than present sources in common use; (2) is modular and, therefore, more adaptable; (3) has a long life span; (4) is portable; (5) operates in damp conditions; (6) uses lower voltage, producing a light display that is much safer to use, install, service and less expensive to operate; (7) generates less heat; and (8) is more durable than glass-based lamps.

Some potential uses for LED lighting have been limited because of various problems, including a need for rigidity in the LED modular lighting unit and environmental conditions such as possible transient exposure to liquids.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a perspective view of a modular system of LED modules and rigid and flexible interconnects according to one embodiment.

FIG. 2 is a perspective view of a portion of the modular system of FIG. 1 with only the rigid interconnect, illustrating an end of one of the LED modules according to one embodiment.

FIG. 3 is a perspective view of a portion of an LED module and an interconnect according to one embodiment.

FIG. 4 is a perspective view of LED modules, an interconnect, and an end cap according to one embodiment.

FIG. 5 is a sectional view of an interconnect connecting two LED modules according to one embodiment.

FIG. 6 is a perspective view of an LED module according to one embodiment.

FIG. 7 is a side view of an LED module according to one embodiment.

FIG. 8 is a cross-sectional view of the LED module of FIG. 7.

FIG. 9 is a perspective view of a modular system of LED modules and rigid and flexible interconnects according to another embodiment.

FIG. 10 is a perspective view of a portion of the modular system of FIG. 9 with only the rigid interconnect, illustrating an end of one of the LED modules according to one embodiment.

FIG. 11 is a perspective view of a portion of an LED module and an interconnect according to one embodiment.

FIG. 12 is a perspective view of LED modules, an interconnect, and an end cap according to one embodiment.

FIG. 13 is a sectional view of an interconnect connecting two LED modules according to one embodiment.

FIG. 14 is a perspective view of an LED module according to one embodiment.

FIG. 15 is a side view of an LED module according to one embodiment.

FIG. 16 is a cross-sectional view of the LED module of FIG. 15.

FIG. 17 is a top and bottom view of the interconnect of FIG. 9.

FIG. 18 is another perspective view of the modular system of FIG. 9.

FIG. 19 is a bottom perspective view of the module system of FIG. 18.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

FIG. 1 is a perspective view illustrating a modular system 100 of LED lighting modules and interconnects according to one embodiment. As illustrated in FIG. 1, two LED modular lighting units 110 are connected by an interconnect 120 that both provides electrical conductivity between two LED modular lighting units 110 and provides rigidity to the connected LED modular lighting units 110. In some embodiments, as many as 16 LED modular lighting units 110 may be connected in a rigid string of LED modular lighting units. In addition, the interconnect 120 may seal an interconnection area so that the interconnection between the LED modular lighting units 110 prevents ingress of dust and is water tight for up to for temporary immersion in up to 1 m of water and carries an Ingress Protection Rating of IP 67.

Also illustrated in FIG. 1 is a flexible interconnect 130 formed of a one-sided interconnect 132 and a one-sided interconnect 134 connected by a flexible cable 136 that provides electrical conductivity between an LED modular lighting unit 110 connected to interconnect 132 and another LED modular lighting unit 110 (not shown) connected to interconnect 134. Thus, the system of LED modular lighting units 110 and interconnects 120 and 130 provides a designer of a lighting installation with the ability to link together LED modular lighting units 110 in both rigid and flexible configurations. One of the one-sided interconnects 132 and 134 may provide a circuit board and female connector for connecting with a male connector of the LED modular lighting unit 110 and the other of the one-sided interconnects 132 and 134 provides a circuit board and male connector for connecting with a female connector of the LED modular lighting unit 110. The interconnects 132 and 134 are otherwise configured as portions of the full interconnect 120 and are not otherwise described herein.

Although only a straight line rigid interconnect 120 is illustrated in FIG. 1, rigid interconnect 120 could be formed with angular connections to allow rigid interconnections at any desired angle. In such an angular interconnect, instead of the LED modular lighting units 110 directly interconnecting as in the straight line interconnect 120 illustrated in FIG. 1, the LED modular lighting units 110 interconnect with circuit boards in each and of the angular rigid interconnect which are electrically connected with each other.

The interconnect 120 and the interconnects 132 and 134 may be formed of any desired material, such as a polycarbonate material. In one embodiment, the interconnect 120 and interconnects 132/134 are formed by injection molding. A central portion of the interconnect 120 is a generally round overmolded housing into which male and female ends of the LED modular lighting units 110 are inserted to form a sealed connection between the LED modular lighting units 110. In one embodiment, the interconnect 120 is formed of a material having a hardness of at least Review70 durometer to provide sufficient stiffness for the interconnected LED modular lighting units 110. Although illustrated as generally round or cylindrical in shape in FIG. 1, other shapes could be used as desired.

Connectivity to a power source may be provided by a pigtail unit that plugs into one end of a LED modular lighting unit 110, an interconnect 120, or one of the split units 132/134 and which is connected to a power source. Alternatively, a power supply may (not shown) be used with one of the split units 132/134 formed as part of the power supply unit.

Additional details are illustrated in the perspective view of FIG. 2. To provide secure insertion of the LED modular lighting units 110 into the interconnect 120, snap fittings 210 (as illustrated holes) may be provided in the interconnect 120 to mate with snap fittings 610 (FIG. 6) on the LED modular lighting units 110 so that upon full insertion of the LED modular lighting unit 110 into the interconnect 120, the snap fittings 210 and 610 engage for removable but secure connection. A female end connector of the LED modular lighting unit 110 is illustrated in FIG. 2. A similar male end connector is formed on the opposite and of the LED modular lighting unit 110 but is not visible in FIG. 2, because it is inserted into the interconnect 120.

In one embodiment, illustrated in FIG. 3, the interconnect 120 may be configured for mounting to another surface (not shown), such as a wall. In one embodiment, the mounting feature includes a slot 310 formed in one end of a base of the interconnect 120, providing an opening for inserting a screw or other type of fastener 320 through the slot 310 for attaching the interconnect 120, and thereby that portion of the modular system 100, to the other surface. In such an embodiment, the bottom portion of the interconnect 120 preferably has a flat surface for mounting flush against the other surface. In some embodiments, instead of using a fastener to hold the interconnect 120 to another surface, adhesives or any other desired way of connecting the interconnect to the other surface may be used. As illustrated in FIG. 3, when the mounting screw 320 is used to attach the interconnect 120 to an external surface, once the LED modular lighting units 110 are inserted into and connected through the interconnect 120, the mounting screw or other fastener 320 is hidden from view and not accessible.

FIG. 4 illustrates an end cap 410 that may be used at an end of a string of LED modular lighting units 110. The end cap 410 snaps on to the LED modular lighting unit 110 as described above and provides a covering for the male or female connectors of the LED modular lighting unit 110. As illustrated in FIG. 4, in one embodiment a mounting tab 420 similar to that provided in the interconnect 120 may be provided in the end cap 410 for mounting that end of the string of LED modular lighting units 110 to another surface. The end cap 410 is generally formed as a closed half of the full interconnect 120 and is not otherwise described herein.

FIG. 5 is a sectional view of two LED modular lighting units 110 connected through an interconnect 120 according to one embodiment. As illustrated, each LED modular lighting unit 110 includes a heat sink 530 that is mounted to a circuit board 580 on which are mounted any desired number of LEDs 510 and any other driving circuitry necessary for the LED modular lighting unit 110. A lens 520 may cover the LEDs 510, typically snapping or otherwise being removably fixed into a housing for the circuit board 580 and LEDs 510. The lens 520 may vary based upon any desired lighting throw.

As illustrated in FIG. 5, a bottom portion 560 of the interconnect 120 extends partially along an underside of the LED modular lighting unit 110, providing rigidity of the interconnection. In addition, an annular portion 570 is formed at the middle of the interconnect 120 to receive the male (540) and female (550) connectors of the LED modular lighting units 110 and provide a seal for the connection between those two connectors. The male connector 540 has a gasket 545, typically an O-ring, to seal with the annular portion 570. Similarly, the female connector 550 as a gasket 555 to seal with the annular portion 570.

Although illustrated in FIG. 5 only extending along the bottom of the LED modular lighting units 110, the bottom portion 560 typically extends up and around at least a portion of the side of the LED modular lighting units 110 to provide stability and rigidity in 2 dimensions, as well as to provide the snap fittings for ensuring the LED modular lighting units 110 stay connected to the interconnect 120. In applications in which a water seal is not needed, the gaskets 545 and 555 may be omitted if desired, but the annular portion 570 would remain to continue to give structural support to the connection and provide rigidity. In some embodiments, instead of mounting the gaskets 545 and 555 in the connectors 540 and 550, gaskets or other sealing elements may be disposed with the annular portion 570.

FIG. 6 is a perspective view of an LED modular lighting unit 110 according to one embodiment. The LED modular lighting unit 110 provides male (620) and female (220) connectors at opposite ends of the LED modular lighting unit 110. Projections 610 are snap fittings intended to engage with the snap fittings 210 of the interconnect 120, to ensure that the LED modular lighting unit 110 is firmly held in the interconnect 120. Although as illustrated, projections 610 are formed on the LED modular lighting unit 110 and holes 210 are formed in the interconnect 120, embodiments can use projections on the interconnect 120 and holes on the LED modular lighting unit 110 the same purpose. Alternate techniques known to the art for holding two objects together may be used. For example, straps or other physical connectors may be provided and attached to a portion of the LED modular lighting units 110 for preventing them from disconnecting from the interconnect 120 instead of the snap fittings 210 and 610. The placement of the snap fittings 210 and 610 is illustrative and by way of example only, and other placements of those fittings may be used as desired.

FIG. 7 is a side sectional view of an LED modular lighting unit 110 according to one embodiment. A male electrical connector 710 extends outward from the male connector 620, and an opening 720 provides access to a female electrical connector for providing electrical connections to the circuit board 580 and LEDs 510. Any desired type of male and female electrical connectors may be used. In one embodiment, instead of using electrical connectors embedded in the ends of the LED modular lighting unit 110 as illustrated herein, the end connectors 620 and 220 may simply provide structural stability and rigidity by mating with the annular portion 570 of the interconnect 120, and other techniques for electrically connecting adjoining LED modular lighting units 110 may be used, such as using an external wire connector (not shown) between the LED modular lighting units 110.

As illustrated in FIG. 7, the heat sink 530 extends nearly to the end of the LED modular lighting unit 110 to engage with the interconnect 120 for providing structural stability and rigidity, as well as to provide adequate heat conduction from LEDs 510 at the ends of the LED modular lighting unit 110. In some embodiments, the heatsink 530 may not extend as far towards the end of the LED modular lighting unit 110 as illustrated, and thermoplastic or other material used for the housing of the LED modular lighting unit 110 may engage with the bottom portion 560 of the interconnect 120 to provide structural stability and rigidity.

FIG. 8 is a cross-sectional end view of the LED modular lighting unit 110 of FIG. 7 along line 8-8. As illustrated in FIG. 8, the heatsink 530 includes a body 820 mounted on the underside of the circuit board 580 and a plurality of fins 810 for conducting heat generated by the LEDs 510 and other electrical components away from the circuit board 580. The heatsink body 820 is mounted with the circuit board 580 and a housing 830 that is overmolded or otherwise formed to hold those elements. In one embodiment, the lens 520 is configured to snap into the housing 830, but may be attached to the housing 830 in any desired fashion and in some embodiments may be omitted altogether. In some embodiments, the fins 810 may be omitted, and other techniques for dispersing heat away from the circuit board 580, such as vent holes in the housing 830 may be provided, as desired.

FIG. 9 is a perspective view illustrating a modular system 100 of LED modular lighting units and interconnects according to another embodiment that uses metal interconnects instead of plastic interconnects for greater strength. As illustrated in FIG. 9, two LED modular lighting units 910 are connected by an interconnect 920 that both provides electrical conductivity between two LED modular lighting units 910 and provides rigidity to the connected LED modular lighting units 910. Any number of LED modular lighting units 110 may be connected in a rigid string of LED modular lighting units. In addition, the LED modular lighting units 910 may seal an interconnection area between the LED modular lighting unit 910 so that the interconnection between the LED modular lighting units 910 prevents ingress of dust and is water tight for up to for temporary immersion. In one embodiment, the seal provides protection in up to 1 m of water and carries an Ingress Protection Rating of IP 67.

Also illustrated in FIG. 9 is a flexible interconnect 930 formed of a one-sided interconnect 932 and a one-sided interconnect 934 connected by a flexible cable 936 that provides electrical conductivity between an LED modular lighting unit 910 connected to interconnect 932 and another LED modular lighting unit 910 (not shown) connected to interconnect 934. Thus, the system of LED modular lighting units 910 and interconnects 920 and 930 provides a designer of a lighting installation with the ability to link together LED modular lighting units 910 in both rigid and flexible configurations. One of the one-sided interconnects 932 and 934 may provide a circuit board and female connector for connecting with a male connector of the LED modular lighting unit 910 and the other of the one-sided interconnects 932 and 934 provides a circuit board and male connector for connecting with a female connector of the LED modular lighting unit 910. The interconnects 932 and 934 are otherwise configured as portions of the full interconnect 920 and are not otherwise described herein.

Although only a straight line rigid interconnect 920 is illustrated in FIG. 9, rigid interconnect 920 could be formed with angular connections to allow rigid interconnections at any desired angle. In such an angular interconnect, instead of the LED modular lighting units 110 directly interconnecting as in the straight line interconnect 920 illustrated in FIG. 9, the LED modular lighting units 910 may interconnect with circuit boards in each and of the angular rigid interconnect which are electrically connected with each other.

The interconnect 920 and the interconnects 932 and 934 may be formed of any desired material, such as aluminum. Although plastic interconnects 920 may be used, metallic interconnects 920 are preferred to provide greater strength and resistance to breakage. As shown in more detail in FIG. 17, a base portion of the interconnect 920 is a generally flat structure configured for insertion into the male and female ends of the LED modular lighting units 910 to form a latched connection between the LED modular lighting units 910. Other shape of the interconnects 920 may be used to correspond to the shapes of the LED modular lighting units 910.

Connectivity to a power source may be provided by a pigtail unit that plugs into one end of a LED modular lighting unit 910, an interconnect 920, or one of the split units 932/934 and which is connected to a power source. Alternatively, a power supply may (not shown) be used with one of the split units 932/934 formed as part of the power supply unit.

Additional details are illustrated in the perspective view of FIG. 10. To provide secure insertion of the interconnect 920 into the LED modular lighting units 910, flexible tabs 1010 may be provided in the interconnect 920 to mate with slots 1530 (FIG. 15) on the LED modular lighting units 910 so that upon full insertion of the interconnect 920 into the LED modular lighting unit 910, the flexible tabs 1010 and slots 1530 engage for removable but secure connection. A male end connector of the LED modular lighting unit 910 is illustrated in FIG. 10. A similar female end connector is formed on the opposite and of the LED modular lighting unit 910 but is not visible in FIG. 10, because it is inserted into the interconnect 120.

In one embodiment, illustrated in FIG. 11, the interconnect 920 may be configured for mounting to another surface (not shown), such as a wall. In one embodiment, the mounting feature includes a hole formed near one end of a base of the interconnect 920, providing an opening for inserting a screw or other type of fastener 1110 through the hole for attaching the interconnect 920, and thereby that portion of the modular system 900, to the other surface. In such an embodiment, the bottom portion of the interconnect 920 preferably has a flat surface for mounting flush against the other surface. In some embodiments, instead of using a fastener to hold the interconnect 920 to another surface, adhesives or any other desired way of connecting the interconnect to the other surface may be used. As illustrated in FIG. 11, when the mounting screw 1110 is used to attach the interconnect 920 to an external surface, once the LED modular lighting units 910 are connected through the interconnect 920, the mounting screw or other fastener 1110 is hidden from view and not accessible.

By providing LED modular lighting units and interconnects as disclosed above, a modular system can provide rigid and/or flexible connection of any desired length and configuration. Although as illustrated herein, the LED modular lighting units 110 and 910 are all of the same size, embodiments may provide LED modular lighting units of different sizes that can be mixed or matched to fit the desired configuration of the composite lighting unit. Because the electrical connections are sealed, the units may be immersed in water or other liquids for temporary periods. The modular system may be used in all types of lighting applications, including signage, cove lighting, accent lighting, task lighting, and case lighting.

FIG. 12 illustrates an end cap unit 1210 that may be used at an end of a string of LED modular lighting units 910. The end cap unit 1210 engages with the LED modular lighting unit 910 as described above and provides a covering for the male or female connectors of the LED modular lighting unit 910. A cover portion 1220 may be formed on the end cap unit 1210 to cover the electrical connector of the LED modular lighting unit 910. The cover portion 1220 may be formed of any desired material, such as a thermoplastic material, and may include a circuit board (not shown) to complete the electrical circuit across the electrical connectors of the LED modular lighting unit 910. As illustrated in FIG. 12, the end cap unit 1210 may also provide a mounting hole 1230 or other capability for mounting the end cap unit 1210 to a surface. The end cap unit 1210 is generally formed as a half of the full interconnect 120 and is not otherwise described herein.

FIG. 13 is a sectional view of two LED modular lighting units 910 connected through an interconnect 920 according to one embodiment. As illustrated, each LED modular lighting unit 910 includes a heat sink 1330 that is mounted to a circuit board 1380 on which are mounted any desired number of LEDs 1310 and any other driving circuitry necessary for the LED modular lighting unit 910. A lens 1320 may cover the LEDs 1310, typically snapping or otherwise being removably fixed into a housing for the circuit board 1380 and LEDs 1310. The lens 1320 may vary based upon any desired lighting throw.

As illustrated in FIG. 13, a bottom portion 1360 of the interconnect 920 extends partially along and engages with an the heat sink 1330 of the LED modular lighting unit 910, providing rigidity of the interconnection. Unlike the embodiment of FIGS. 1-8, an annular portion 1370 is formed as part of or as an attachment to an end of one of the interconnected LED modular lighting units 910 to receive the male (1340) and female (1350) connectors of the LED modular lighting units 910 and provide a seal for the connection between those two connectors. The male connector 1340 in one embodiment has an area of flexible wickers 1355 to seal with the annular portion 1370. The annular portion 1370 is typically formed of a thermoplastic material, which may be the same as or different from that of the thermoplastic material used on the rest of the LED modular lighting units 910. Other techniques for sealing the electrical connectors with the annular portion, such as gaskets or O-rings, may be used as desired.

Although illustrated in FIG. 5 as attached to the female connector 1350 of the LED modular lighting unit 910, the annular portion 1370 may be attached to either male or female connectors as desired. In one embodiment, the annular portion 1370 is removable and may be attached to the male or female connectors 1340/1350 before joining the LED modular lighting units 910.

Although illustrated in FIG. 13 only extending along the bottom of the LED modular lighting units 910, the bottom portion 1360 typically engages with a portion of the underside of the LED modular lighting units 910 to provide stability and rigidity in 2 dimensions, as well as to provide the flexible fittings for ensuring the LED modular lighting units 910 stay connected to the interconnect 920. In applications in which a water seal is not needed, the annular portion 1370 may be omitted. In some embodiments, instead of or in addition to forming flexible wickers 1355 on the electrical connectors 1340/1350, flexible wickers may be formed on an interior surface of the annular portion 1370.

FIG. 14 is a perspective view of an LED modular lighting unit 910 according to one embodiment. The LED modular lighting unit 910 provides male and female connectors at opposite ends of the LED modular lighting unit 910. A housing 1410, typically of a thermoplastic material, is disposed about the circuit board 1380 (not visible in FIG. 14) and a portion of the lens 1320 that covers the LEDs 1310 (not visible in FIG. 14). The housing 1410 typically snaps onto or it otherwise removably fixed over the circuit board 1380 and lens 1320.

FIG. 15 is a side sectional view of an LED modular lighting unit 910 according to one embodiment. A male electrical connector 1510 extends outward from the male connector 1350, and an opening 1520 provides access to a female electrical connector for providing electrical connections to the circuit board 1380 and LEDs 1310. Any desired type of male and female electrical connectors may be used. In one embodiment, instead of using electrical connectors embedded in the ends of the LED modular lighting unit 910 as illustrated herein, other techniques for electrically connecting adjoining LED modular lighting units 110 may be used, such as using an external wire connector (not shown) between the LED modular lighting units 910.

As illustrated in FIG. 15, the heat sink 1330 extends nearly to the end of the LED modular lighting unit 910 to engage with the interconnect 920 for providing structural stability and rigidity, as well as to provide adequate heat conduction from LEDs 1310 at the ends of the LED modular lighting unit 910. A slot 1530 is configured to engage with tabs on the interconnect 920, removably locking the interconnect 920 in place to resist disengagement until the tab is removed from the slot 1530. In one embodiment, one slot 1530 is disposed on one side of the heat sink 1330 and a second slot 1530 is disposed on a second side of the heat sink 1330, for connecting with interconnects 920 engaged with each end of the heat sink 1330; however, embodiments may form both slots 1530 on the same side if desired.

FIG. 16 is a cross-sectional end view of the LED modular lighting unit 910 of FIG. 15 along line 16-16. As illustrated in FIG. 16, the heat sink 1330 includes a body 1620 mounted on the underside of the circuit board 1380 and a plurality of fins 1610 for conducting heat generated by the LEDs 1310 and other electrical components away from the circuit board 1380. The heat sink body 1620 is mounted with the circuit board 1380 and the housing 1410 that is overmolded or otherwise formed to hold those elements. In one embodiment, the lens 1320 is configured to snap into the housing 1410, but may be attached to the housing 1410 in any desired fashion and in some embodiments may be omitted altogether. Channels 1630 are formed on either side of the body 1620 to engage the base of the interconnect 920, providing a rigid connection between the LED modular lighting unit 910 and the interconnect 920.

FIG. 17 is a top and bottom view of the interconnect 920 according to one embodiment. A base portion 1710, typically formed of aluminum, is generally flat, corresponding to the generally flat shape of the heat sink 1330. At both ends of the base portion 1710 flexible tabs 1730 and 1740 are positioned for engaging with the slots 1530 formed in the heat sink 1330, preventing disengagement of the interconnect 920 from the LED modular lighting unit 910 without disengaging the tabs 1730 and 1740 from the slots 1530. The tabs 1730 and 1740 are typically of a spring steel, but may be formed of any desired material. The tabs 1730 and 1740 are attached to the base portion 1710 in one embodiment by the use of holes 1752 and pins 1750, such as PEM® SPOTFAST® fasteners. (PEM and SPOTFAST are registered trademarks of PEM Management, Inc.) Any desired technique for attaching the tabs 1730 and 1740 to the base portion 1710 may be used, including welding or any other type of bonding. In one embodiment, tab 1730 is oriented in an opposite direction from tab 1740, with each engaging an opposite slot 1530 on the heat sink 1330. Other embodiments may orient both tabs 1730 and 1740 in the same direction.

Foam pads 1720 may be placed on the top side of the base portion, to engage with an underside of the heat sink 1330 to improve the connection between the interconnect 920 and the LED modular lighting unit 910. Mounting holes 1760 in one embodiment are formed in the base portion 1710 to allow mounting the interconnect 920 to a surface. Although four mounting holes 1760 are illustrated in FIG. 17, any number of mounting holes 1760 may be used. The interconnect 920 may be of any desired length.

As illustrated in FIG. 17, rails 1770 are formed on both sides of the base portion 1710, configured to engage the channels 1630 of the heat sink 1330, providing rigid interconnection of the interconnect 920 with the LED modular lighting unit 910. In another embodiment, channels may be formed on the base portion 1710 for engagement with rails on the heat sink 1330.

FIGS. 18 and 19 are perspective views of the top and bottom of LED modular lighting units 910 and interconnects 920 in various stages of interconnection, ranging from initial insertion, partial connection, and fully engaged. In this example, two of the interconnects are two-way interconnects 920 and one is a one-way interconnect 932 for a flexible connection.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A LED modular lighting system, comprising:
a plurality of LED lighting modules; and
an interconnect, configured to engage a first end of a first LED lighting module of the plurality of LED lighting modules having a first electrical connector and a second end of a second LED lighting module of the plurality of LED lighting modules having a second electrical connector to form a rigid electrically connected connection between the first LED lighting module and the second LED lighting module.

2. The LED modular lighting system of claim 1,
wherein engagement of the interconnect with the first LED lighting module and the second lighting module causes a sealed electrical connection between first electrical connector of the first LED lighting module and the second electrical connector of the second LED lighting module.

3. The LED modular lighting system of claim 1,
wherein the interconnect is mountable to an external surface at a mounting point that is inaccessible and hidden from view upon engaging the first LED lighting module and the second LED lighting module with the interconnect.

4. The LED modular lighting system of claim 1,
wherein the interconnect is configured to resist disengagement of the first LED lighting module from the interconnect.

5. The LED modular lighting system of claim 1, further comprising:
a flexible interconnect, comprising:
a first one-way interconnect, configured to engage an electrical connector of the first LED lighting module of the plurality of LED lighting modules;
a second one-way interconnect, configured to engage an electrical connector of the second LED lighting module of the plurality of LED lighting modules; and
a cable electrically connecting the first one-way interconnect and the second one-way interconnect, providing electrical conductivity between the first LED lighting module and the second LED lighting module,
wherein the first one-way interconnect is rigidly engaged with the first LED lighting module and the second one-way interconnect is rigidly engaged with the second LED lighting module.

6. The LED modular lighting system of claim 1, further comprising:
an end cap unit, configured to engage an end of an LED lighting module of the plurality of LED lighting modules.

7. The LED modular lighting system of claim 6, wherein the end cap unit is mountable to an external surface at a mounting point.

8. An interconnect for a LED modular lighting system, comprising:
a base portion; and
a pair of rails, extending along the sides of the base portion, each of the pair of rails configured to engage with corresponding channels of an LED modular lighting unit to form a rigid connection with the LED modular lighting unit.

9. The interconnect of claim 8, further comprising:
a flexible tab, attached to the base portion, configured to engage a slot formed in the LED modular lighting unit.

10. The interconnect of claim 8, wherein the base portion is formed from a metallic material.

11. The interconnect of claim 8, wherein the interconnect is configured to engage with a second LED lighting module.

12. The interconnect of claim 8, wherein the base portion comprises:
a mounting portion, configured for mounting the interconnect to a surface.

13. The interconnect of claim 8, further comprising:
a foam pad disposed on a surface of the base portion, configured to engage with the LED modular lighting unit.

14. An LED lighting module, comprising:
a housing;
a plurality of LEDs, disposed with the housing;
a first electrical connector disposed at a first end of the housing; and
a second electrical connector disposed at a second end of the housing,
wherein the LED lighting module is configured to engage with an interconnect, forming a rigid connection with the interconnect.

15. The LED lighting module of claim 14, further comprising:
a heat sink, disposed with the plurality of LEDs and the housing, comprising:
a pair of channels along the sides of the heat sink, configured to engage with the interconnect,
wherein the heat sink extends along a portion of the housing opposite to the plurality of LEDs.

16. The LED lighting module of claim 15, wherein the heat sink comprises:
a slot, configured to engage with a flexible fitting of the interconnect.

17. The LED lighting module of claim 14, further comprising:
a sealing portion, disposed with the first electrical connector, configured to seal with an opposite electrical connector of a second LED lighting module.

18. The LED lighting module of claim 17, wherein the sealing portion is removably attached to the housing of the LED lighting module.

19. The LED lighting module of claim 17, wherein the second electrical connector comprises:
an annular area surrounding a portion of the second electrical connector, configured to seal with a sealing portion unit of another LED lighting module.

20. The LED lighting module of claim 14, further comprising:
a circuit board on which the plurality of LEDs are mounted; and
a lens disposed over the circuit board and engaged with the housing.
